(19) United States
(12) Patent Application Publication
(10) Pub. No.: US 2014/0209718 A1
(43) Pub. Date: Jul. 31, 2014

(54) BIOLOGICAL FLUID CONTAINER SHREDDER

(71) Applicant: Government of the United States as Represented by the Secretary of the Air Force, (US)

(72) Inventor: Joshua D. Bevins, Dayton, OH (US)

(73) Assignee: Government of the United States as Represented by the Secretary of the Air Force, Wright-Patterson AFB, OH (US)

(21) Appl. No.: 13/750,060

(22) Filed: Jan. 25, 2013

(51) Int. Cl. B02C 23/10; B02C 18/16

(52) U.S. Cl. CPC B02C 23/10; B02C 18/16
USPC 241/24.11; 241/79; 241/66; 241/79.2

(57) ABSTRACT

A device for disposing of a container having a biological fluid contained therein. The device includes a housing having a first end and a second end. Proximate the first end is an opening through which the container is received. A shredding chamber, between the opening and the second end and within the housing, is configured to break the container into a plurality of pieces. A collection grid is positioned between the shredding chamber and the second end and within the housing. The collection grid is slidable with respect to the housing and is porous to the biological fluid and not to the plurality of pieces. A port, proximate the second end, is configured form removal of the biological fluid from the housing.

### RIGHTS OF THE GOVERNMENT

The invention described herein may be manufactured and used by or for the Government of the United States for all governmental purposes without the payment of any royalty.

### FIELD OF THE INVENTION

The present invention relates generally to biological fluid disposal and, more specifically, to apparatii and methods of disposing biological fluid containers.

### BACKGROUND OF THE INVENTION

Biological fluids, both excreted and secreted, provide details with respect to an individual's health and/or genetic makeup. Secreted fluids (blood, plasma, semen, saliva, and urine) and excreted fluids (feces, vomit, bile, and sebum) may provide pharmacological data (metabolism of drugs), pathological data (presence of disease), and/or forensic data (evidence associated with a crime). More specifically, and for example, urine may be analyzed for the presence of ketones (indication of dehydration), bacteria (indication of a urinary tract infection), abnormal calcium levels (indication of kidney stones), or controlled metabolites of substances (such as performance enhancing steroids, cannabis, cocaine, heroin, opiates, amphetamines, and barbiturates). Blood may be analyzed for basic metabolic panels (sodium, potassium, chloride, bicarbonate, blood urea nitrogen, magnesium, creatine, glucose, and calcium), cholesterol levels (LDL and HDL), liver function, DNA (such as in paternity testing), or cellular evaluations (leukocytes, erythrocytes, and platelets).

A biological fluid specimen, whether collected directly (such as a blood draw) or indirectly (such as residues at a crime scene), may be placed into a fluid tight container for storage and transport to a laboratory for sampling and analysis.

Testing and analysis requires only a small volume, i.e., a sample, of the acquired specimen. Accordingly, a volume of specimen often remains after analysis is complete and requires disposal. A laboratory technician may dispose of the remaining volume with the fluid tight container in a biohazard trash receptacle or open the fluid tight container, pour the remaining volume into a biohazard drain, and dispose of the fluid tight container in a biohazard trash receptacle. Disposing of the specimen via the biohazard trash receptacle increases the weight and volume of biohazard waste, which increases the costs associated with proper disposal thereof. Disposing of the specimen via the biohazard drain increases the amount of time spent in disposing specimens and increases the chance of exposure, e.g., by splashing.

As a result, there remains a need for apparatii and methods for timely and efficiently disposing of biological fluid specimens without exposing the laboratory technician to the risk of exposure.

### SUMMARY OF THE INVENTION

The present invention overcomes the foregoing problems and other shortcomings, drawbacks, and challenges of biological fluid specimen disposal after analysis is complete. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention a device for disposing of a container having a biological fluid contained therein includes a housing having a first end and a second end. Proximate the first end is an opening through which the container is received. A shredding chamber, between the opening and the second end and within the housing, is configured to break the container into a plurality of pieces. A collection grid is positioned between the shredding chamber and the second end and within the housing. The collection grid is slidable with respect to the housing and is porous to the biological fluid and not to the plurality of pieces. A port, proximate the second end, is configured to allow removal of the biological fluid from the housing.

Another embodiment of the present invention is directed to a device for disposing of a container having a biological fluid contained therein. The device includes a housing having a first end and a second end. Proximate the first end is an opening through which the container is received. A shredding chamber, between the opening and the second end and within the housing, is configured to break the container into a plurality of pieces. A collection grid is positioned between the shredding chamber and the second end and within the housing. The collection grid is porous to the biological fluid and not to the plurality of pieces. A refrigeration unit is operably coupled to the housing and configured to reduce a temperature therein.

According to one embodiment of the present invention is directed to a method of disposing of biological fluid containers having biological fluids with a shredder comprising a housing having first and second ends and an opening proximate the first end. The biological fluid containers are deposited into the shredder through the opening in the housing such that the biological fluid containers engage a shredder head configured to break the biological fluid containers into a plurality a pieces. A collection grid, having the plurality of pieces thereon, is removed from the housing. The biological fluid is removed proximate the second end of the housing.

The above and other objects and advantages of the present invention shall be made apparent from the accompanying drawings and the descriptions thereof.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view of a biological fluid container shredder in accordance with one embodiment of the present invention.

FIG. 2 is a perspective view of the biological fluid container shredder of FIG. 1 with the door opened to expose a container receiver bin.

FIG. 3 is a cross-sectional view of the biological fluid container shredder taken along Line 3-3 in FIG. 1.

FIG. 4 is a cross-sectional view of the biological fluid container shredder taken along Line 4-4 in FIG. 1.

FIG. 5 is a perspective view of the biological fluid container shredder of FIG. 1 with a drawer opened to expose a collection grid.

### DETAILED DESCRIPTION OF THE INVENTION

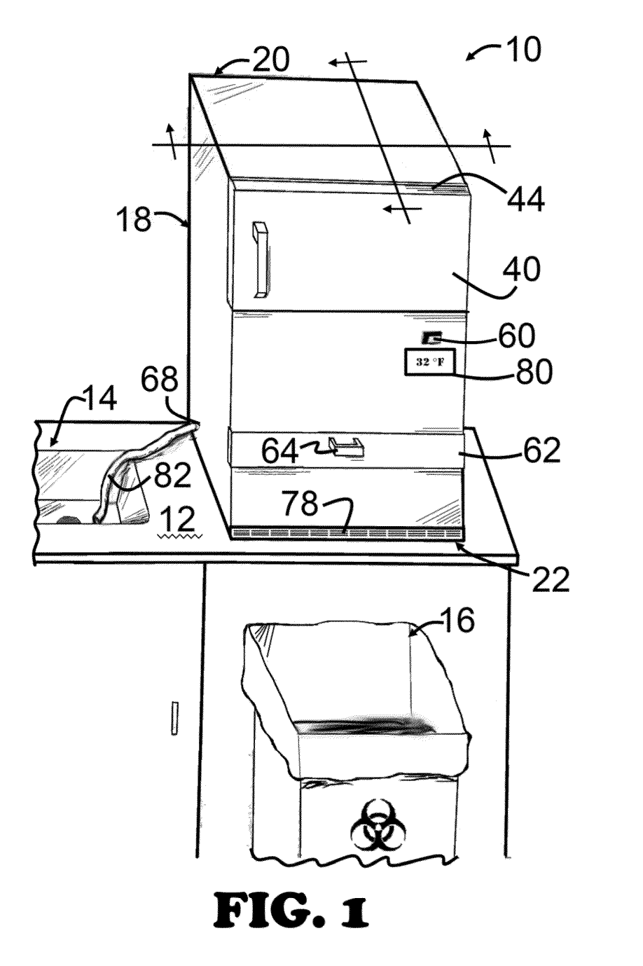

Turning now to the figures, and in particular to FIG. 1, a biological fluid container shredder 10 (hereafter, “shredder” 10) in accordance with one embodiment of the present invention is shown. The shredder 10, as shown, may be placed on a countertop 12, proximate a sink 14, and, if desired, also proximate a biohazard waste receptacle 16.

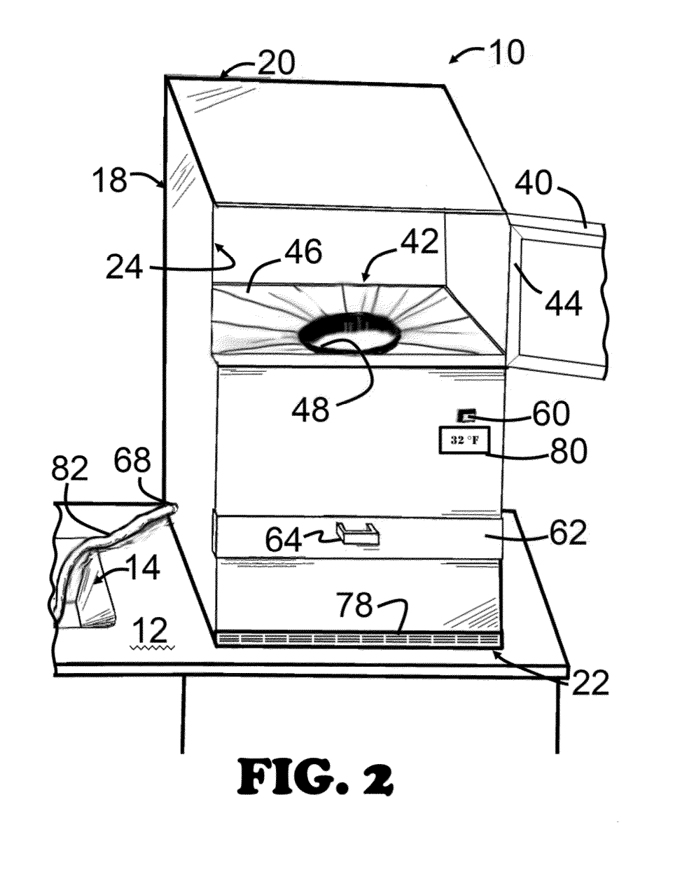

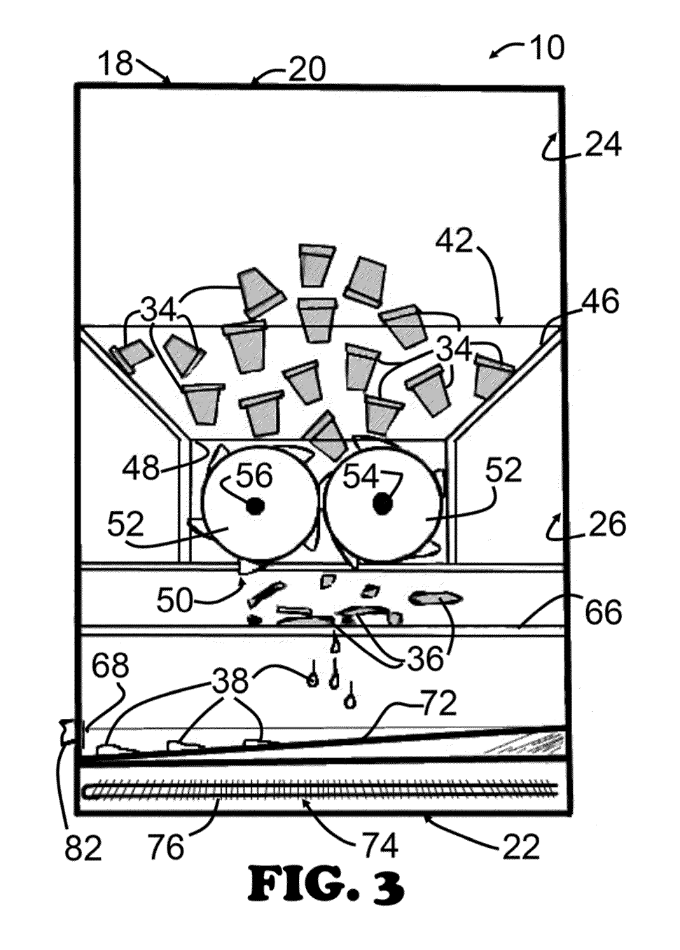

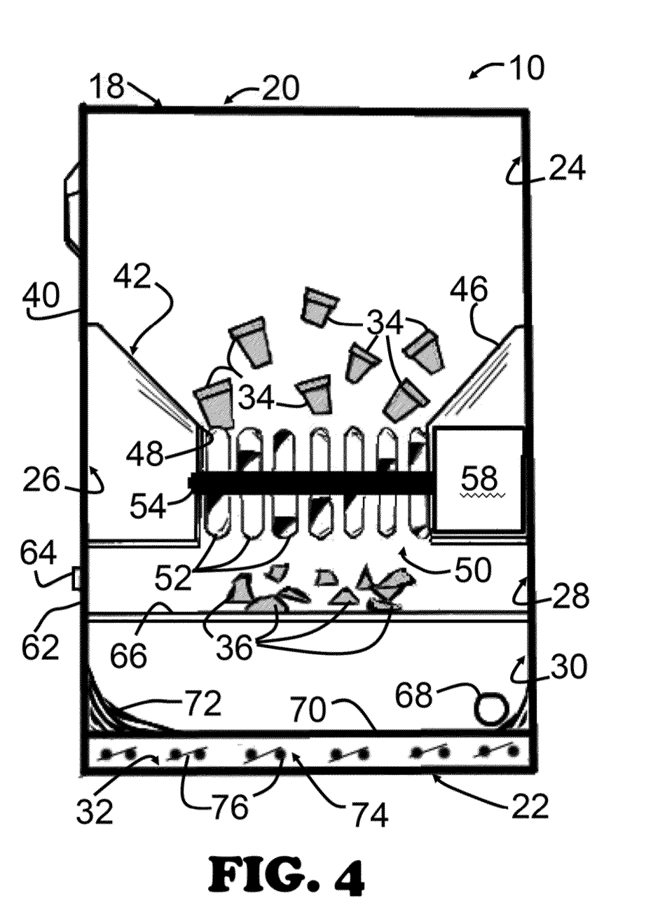

The shredder 10 includes a housing 18 having a first end 20 and a second end 22. Positioned within the housing 18 and between the first and second ends 20, 22, the shredder 10 includes a receiving chamber 24 (FIG. 2), a shredding chamber 26 (FIG. 3), a solid collection chamber 28 (FIG. 4), a fluid collection chamber 30 (FIG. 4), and, optionally, a refrigeration chamber 32 (FIG. 4). Generally, one or more biological fluid containers (hereafter, “containers” 34), are received by the shredder 10 in the receiving chamber 24. In the illustrative embodiment, the received containers 34 enter, under force of gravity, the shredding chamber 26 and are broken into a plurality of pieces 36 (FIG. 3). The plurality of pieces 36 is collected within the solid collection chamber 28 for removal at a later time. The solid collection chamber 28 is positioned between the shredding chamber 26 and the second end 22 of the housing 18. Biological fluids 38 within the containers 34, released within the shredding chamber 26 when the container are broken, flow through the solid collection chamber 28 and are collected within the fluid collection chamber 30, which is positioned between the solid collection chamber 28 and the second end 22 of the housing 18.

More particularly, and with reference now to FIGS. 1 and 2, a door 40 coupled to the housing 18 provides access to the receiving chamber 24, which includes a hopper 42 therein. The door 40 may be side, hingedly-coupled to the housing 18, for example, as is shown. Alternatively, although not specifically shown, the door 40 may be coupled to the housing 18 via a top hinge, in sliding relation, or removable. In any event, the door 40 may include a gasket 44 configured to form a fluid-tight seal with the housing 18, which facilitates internal refrigeration of the shredder 10, as described in detail below.

The hopper 42 within the receiving chamber 24 is configured to receive the containers 34 and to direct the same into the shredding chamber 26. While the shape of the hopper 42 may vary, the illustrative embodiment includes a conically-shaped collar 46 terminating at an inlet 48 to the shredding chamber 26. In this way, the hopper 42 and the in et 48 may be sized and shaped to protect the user from injury.

The shredding chamber 26, as shown in FIGS. 3 and 4, includes a shredder head 50 configured to break walls of the containers 34, which consequently releases the biological fluid 38 from therein. In that regard, the illustrative shredder head 50 includes a plurality of cutting blades 52 on first and second shafts 54, 56, which are operably coupled to a drive system (illustrated as a motor 58 in FIG. 4), configured to drive the shafts 54, 56 in respective opposing, rotating directions. The cutting blades 52 may be configured for strip-cut, cross-cut, micro-cut, pierce-and-tear, and so forth, if desired. it would be readily appreciated by the skilled artisan having the benefit of the disclosure provided herein that other destroying or pulverizing mechanisms may alternatively be used, including, for example, disintegrators, hammer mills, granulators, choppers, and grinders. Still other embodiments, although not specifically shown, a secondary processing chamber may be downstream of the shredding chamber 26 (i.e., closer to the second end 22 of the housing 18), by which the plurality of pieces 36 may be further broken, pulverized, granulated, or chopped. One such example may include a grinding mill.

The motor 58 may be operable by way of a switch 60, by which the user may turn power to motor 58 on or off. Alternatively, the motor 58 may be operably coupled to the door 40. i.e., power to the motor 58 is turned on when the door 40 opens or a set time delay after the door 40 is closed. The motor 58 may be operated before, during, or after depositing containers 34 into the hopper 42. If desired, one or more safety switches (not shown) may be incorporated. One such safety switch may restrict power to the motor 58 while a drawer 62 to the solid collection chamber 28 is open. Another such safety switch may restrict power to the motor 58 while the door 40 is open. Other arrangements and switches may be included and would be readily appreciated by ordinary artisans.

With the containers 34 broken into pieces 36, and consequently the biological fluid 38 released from the containers 34, the pieces 36, and the biological fluid 38 move from the shredding chamber 26 to the solid and fluid collection chambers 28, 30.

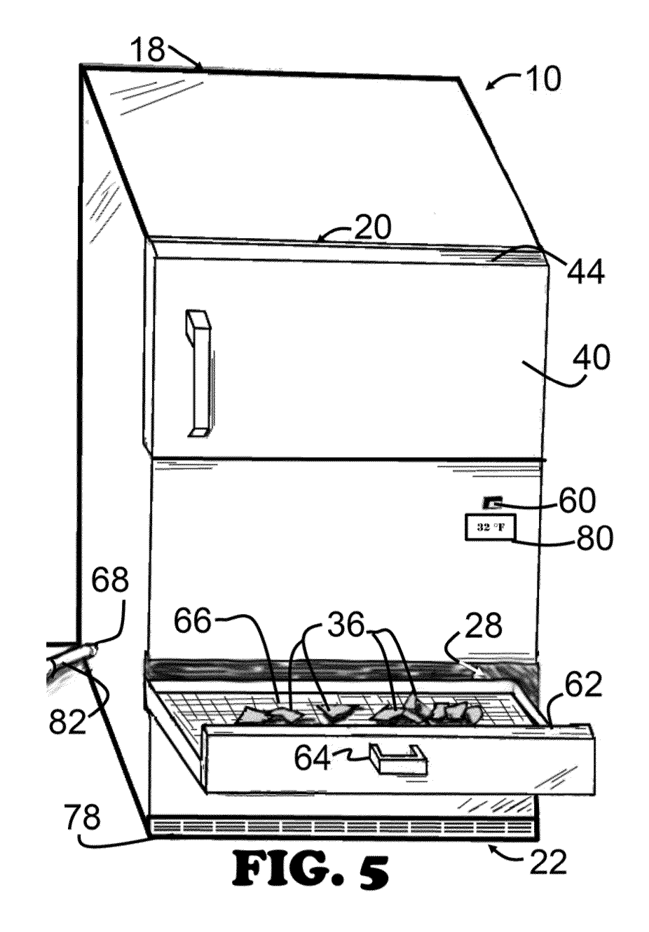

FIG. 5, with continued reference to FIGS. 3 and 4, the drawer 62 of the solid collection chamber 28 may include a handle 64, may be in slidable relation to the housing 18, and includes a collection grid 66 therein. When the drawer 62 is positioned within the housing 18, the pieces 36, broken from the containers 34 within the shredding chamber 26, fall onto and are retained by the collection grid 66; however, the collection grid 66 is porous to the biological fluid 38. Accordingly, while pieces 36 are retained, the biological fluid 36 flows through the collection grid 66 and enters the fluid collection chamber 30.

Sliding the drawer 62 outwardly with respect to the housing 18 permits access to the collection grid 66 for removal of the pieces 36. Indeed, in some embodiments, the drawer 62 may be completely removed from the housing 18 such that the pieces 36 may be disposed directly into the waste receptacle 16 (FIG. 1), for cleaning the drawer 62, or both.

While the collection grid 66 may be constructed of a variety of materials, noncorrosive materials having a tensile strength suitable for supporting pieces of the containers are beneficial. The construction materials, such as screens, mesh, or perforated stainless steel may also be treated to reduce corrosion and/or bacterial growth. For example, Microban® (Microbran, International, Huntersville, N.C.) is an antimicrobial product that may be incorporated into the collection grid material for reducing bacterial, mold, and mildew growth.

Referring again to FIGS. 3 and 4, the biological fluid 38 flows through the collection grid 66 and enters the fluid collection chamber 30. The fluid collection chamber 30, proximate the second end 22 of the housing 18, includes a port 68 in fluid communication therewith for biological fluid removal. As is shown in FIGS. 3 and 4, a bottom surface 70, side walls 72, or both of the fluid collection chamber 30 may be angled or sloped toward the port 68 such that the biological fluid 38 flows and pools proximate thereto.

The port 68 may be fluidically coupled to the sink 14 such as by a pipe or tube 82, as shown in FIG. 1, or a fluid receptacle (such as a large, fluid storage container). Alternatively, the port 68 may be plugged not shown) and biological fluid 38 retained within the fluid collection chamber 30 until removal at a later time.

As alluded to above, and if desired, the shredder 10 may include a refrigeration unit 74 configured to cool internal spaces of the shredder 10 to a desired temperature so as to reduce bacterial growth. In that regard, a condenser coil 76 may be provided within the refrigeration chamber 32 with a vented guard panel 78 positioned proximate the second end 22 of the housing 18 and to provide air flow to the condenser coil 76. Although not specifically shown herein, the condenser coil 76 may be coupled to a condenser and evaporator coil, as is known to those of ordinary skill in the art. Furthermore, the refrigeration unit 74 may be operably coupled to a controller (not shown), which is, in turn, operably coupled to a user input device 80, which enables a user to do one or more of increase temperature, decrease temperature, turn power to refrigeration unit 74 on, turn power to refrigeration unit 74 off, and display current temperature.

Although not specifically shown herein, the housing 18 may include additional doors or openings to facilitate cleaning and sanitization of the chambers 24, 26, 28, 30, 32 within the housing 18. Additionally or alternatively, an internal disinfectant supply may be provided, which may spray a disinfectant or cleaner in one or more chambers 24, 36, 28, 30, 32 of the housing 18 when the motor 58 is running, after the motor 58 stops, at regular time intervals, or combinations thereof.

A device, as provided herein, is configured for shredding a container having a biological fluid contained therein. Various embodiments of the device, as provided herein, lend themselves to a small footprint construction so that the device may be easily positioned on a laboratory countertop. The device enables disposal of a large number of containers, and the associated biological fluids, in a safe and efficient manner and reduces waste removal costs.

While the present invention has been illustrated by a description of various embodiments, and while these embodiments have been described in some detail, they are not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with methods of practicing the present invention as currently known. However, the invention itself should only be defined by the appended claims.

What is claimed is:

1. A device fur disposing of a container having a biological fluid contained therein, the device comprising:
a housing having a first end and a second end;
an opening, proximate the first end of the housing and is configured to receive the container therethrough;
a shredding chamber within the housing and between the opening and the second end, the shredding chamber is configured to break the container into a plurality of pieces;
a collection grid in sliding relation to the housing between the shredding chamber and the second end, the collection grid being, porous to the biological fluid and not porous to the plurality of pieces; and
a port fluidically coupled to the housing, proximate the second end, is configured to remove the biological fluid from the housing.

2. The device of claim 1, further comprising:
a refrigeration unit configured to reduce a temperature within the housing.

3. The device of claim 1, further comprising:
a fluid collection chamber having at least one sloping wall, the sloping wall being angled toward the port.

4. The device of claim 1, wherein the port if fluidically coupled to a fluid receiving receptacle.

5. The device of claim 1, wherein the shredding chamber includes at least one shredder head and drive system operably coupled to the at least one shredder head.

6. The device of claim 5, wherein the at least one shredder head includes a plurality of cutting blades coupled to first and second shafts and the drive system is configured to drive the first and second shafts in opposing, rotating directions.

7. The device of claim 6, wherein the cutting blades are configured for strip-cutting, cross-cutting, micro-cutting, pierce-and-tearing, or a combination thereof.

8. A device for disposing of a container having a biological fluid contained therein, the device comprising:
a housing having a first end and a second end;
an opening proximate the first end of the housing and is configured to receive the container:
a shredding chamber within the housing and between the opening and the second end, the shredding chamber configured to break the container into a plurality of pieces;
a collection grid within the housing and between the shredding, chamber and the second end, the collection grid being porous to the biological fluid and not porous to the plurality of pieces;
a fluid collection chamber within the housing and between the collection grid and the second end; and
a refrigeration unit operably coupled to the housing and is configured to reduce a temperature therein.

9. The device of claim 8, wherein the collection grid is in sliding relation to the housing.

10. The device of claim 8, further comprising:
a port fluidically coupled to the fluid collection chamber and configured to drain biological fluid therefrom.

11. The device of claim 10, wherein the fluid collection chamber includes at least one sloping wall angled to the port.

12. The device of claim 8, wherein the shredding chamber includes at least one shredder head and drive system operably coupled to the at least one shredder head.

13. The device of claim 12, wherein the at least one shredder head includes a plurality of cutting blades coupled to first and second shafts and the drive system is configured to drive the first and second shafts in opposing, rotating directions

14. A method of disposing of biological fluid containers having biological fluids therein in a shredder, the shredder comprising a housing having a first end and a second end, the method comprising:
depositing biological fluid containers through an opening in the housing proximate the first end such that the biological fluid containers engage a shredder head configured to break the biological fluid containers into a plurality of pieces;
removing a collection grid from the housing, the collection grid having the plurality of pieces thereon; and
removing the biological fluid proximate the second end of the housing.

15. The method of claim 14, further comprising:
transferring the plurality of pieces from the collection grid to a waste receptacle.
